(19) United States
(12) Patent Application Publication
(10) Pub. No.: US 2010/0030913 A1
(43) Pub. Date: Feb. 4, 2010

(54) COMMUNICATION CONTROLLING METHOD FOR NETWORK MANAGING DEVICE

(76) Inventors: Jong-Hoon Chung, Gyeonggi-do (KR); Jun-Wan Bano, Seoul (KR); Sang-Tae Chung, Seoul (KR); Sang-Kyun Lee, Seoul (KR)

Correspondence Address: LEE, HONG, DEGERMAN, KANG & WAIMEY, 660 S. FIGUEROA STREET, Suite 2300, LOS ANGELES, CA, 90017, US

(21) Appl. No.: 12/519,208

(22) PCT Filed: Jan. 17, 2008
(86) PCT No.: PCT/KR2008/000303

§ 371 Date: Jun. 15, 2009

(30) Foreign Application Priority Data
Jan. 17, 2007 (KR) 10-2007-005301

(51) Int. Cl. G06F 15/16

(52) U.S. Cl. 709/233

(57) ABSTRACT

The present invention relates to a communication controlling method, and more particularly, to a communication controlling method for a network managing device that can control a speed of a network and a transmission/reception amount of packets according to a communication situation. A communication controlling method for a network managing device includes the steps of judging a speed of a connected network or a transmission/reception amount of packets, setting an increase/decrease amount of an event transmission interval of a network device according to the judgment result, and transmitting the set increase/decrease amount of the event transmission interval to the network device through the network.

### TECHNICAL FIELD

The present invention relates to a communication controlling method, and more particularly, to a communication controlling method for a network managing device that can control a network speed or a transmission/reception amount of packets to a communication situation.

### BACKGROUND ART

In general, a home network means a network connecting various electric home appliances installed in a house to each other so that a user can conveniently and safely enjoy economical life services anytime inside or outside the house.

Normally, a home network system uses a wire communication network such as a power line or RS-485 and a wireless communication network such as RF or Zigbee as communication media. The home network system includes a gateway for use in communication between hetero-networks (for example, communication between power line and RS-485, communication between power line and Zigbee, etc.), one or more network managing devices that are master devices, and one or more network devices that are slave devices.

The network device performs its own operation, or transmits an event caused by a user to the network managing device. The low-speed communication medium is mostly used as the network applied to the home network system. The network devices are various electric appliances, such as a TV, refrigerator, washing machine, microwave oven, etc., and are provided with a connection interface (for example, a modem, etc.) connectable to the network mentioned above.

As kinds and functions of the network devices are diversified, various events occur in the network devices, and thus event packets increase. The packet transmission using the network that is the communication medium also increases. In a state where the low-speed communication medium is used, the increase of the packet transmission adversely affects the network. As a result, data and packets are transmitted at a low speed.

In addition, when packets are transmitted frequently between hetero-communication media, the packet transmission using the gateway increases. Therefore, a serious traffic problem occurs in each gateway.

Moreover, when the network is a high-speed communication medium, if an event transmission interval is relatively large, a service is inefficiently slowly performed. Meanwhile, when the network is a low-speed communication medium, if an event transmission interval is relatively small, a traffic problem occurs in the network.

### DISCLOSURE OF INVENTION

### Technical Problem

In order to solve the aforementioned problems, an object of the present invention is to provide a communication controlling method for a network managing device that can adjust an event transmission interval of each network device according to a speed of a communication medium that is a network or a transmission/reception amount of packets.

Another object of the present invention is to provide a communication controlling method for a network managing device that can set and adjust an event transmission interval according to a characteristic of an event.

A further object of the present invention is to provide a communication controlling method for a network managing device that can control a traffic by restricting repeated double transmission of an event.

### Technical Solution

According to an aspect of the present invention, there is provided a communication controlling method for a network managing device, including the steps of: judging a speed of a network connected with the network managing device or a transmission/reception amount of packets; setting an increase/decrease amount of an event transmission interval of a network device according to the judgment result; and transmitting the set increase/decrease amount of the event transmission interval to the network device through the network. It is thus possible to control the event transmission directly by reflecting the speed of the network or the transmission/reception amount of the packets.

Preferably, the setting step sets the increase/decrease amount as a constant value for all events.

Preferably, the setting step sets the increase/decrease amounts individually according to kinds of events.

Preferably, the setting step sets the increase/decrease amount to be proportional to the transmission/reception amount of the packets over the network.

Preferably, the setting step decreases the event transmission interval when the network has a high speed, and increases the event transmission interval when the network has a low speed.

Preferably, the network managing device is a master device or a gateway.

According to another aspect of the present invention, there is provided a communication controlling method for a network device, including the steps of: receiving an increase/decrease amount of an event transmission interval from a network managing device; and when an event occurs, transmitting a packet corresponding to the event to the network managing device at the event transmission interval reflected with the increase/decrease amount.

Preferably, the transmitting step includes a step of computing the event transmission interval according to the increase/decrease amount.

Preferably, the computing step adds or subtracts the increase/decrease amount to/from the event transmission interval according to kinds of events.

According to a further aspect of the present invention, there is provided a communication controlling method for a network managing device, including the steps of: receiving an event packet from a network device; and transmitting an event response packet to the network device with respect to the event packet.

According to a still further aspect of the present invention, there is provided a communication controlling method for a network device, including the steps of: when an event occurs, transmitting an event packet corresponding to the event to a network managing device; receiving an event response packet corresponding to the event packet from the network managing device; and stopping the transmission of the event packet corresponding to the event according to the event response packet.

### ADVANTAGEOUS EFFECTS

According to the present invention, an event transmission interval of each network device is adjusted according to a speed of a communication medium that is a network or a transmission/reception amount of packets. Therefore, optimum data communication can be carried out.

In addition, according to the present invention, an event transmission interval is set on the basis of a characteristic of an event. It is thus possible to transmit an urgent event rapidly.

Moreover, according to the present invention, repeated double transmission of an event is restricted to control a transmission/reception amount of packets. Accordingly, a data transmitting and processing speed can be improved.

### BRIEF DESCRIPTION OF THE DRAWINGS

FIG. 1 is a configuration view illustrating a home network system applied with a communication controlling method for a network managing device according to the present invention;

FIG. 2 is a configuration view illustrating a master device that is a network managing device of FIG. 1;

FIG. 3 is a configuration view illustrating a gateway that is a network managing device of FIG. 1;

FIG. 4 is a configuration view illustrating a slave device that is a network device of FIG. 1;

FIG. 5 is a flowchart showing a communication controlling method according to a first embodiment of the present invention; and

FIG. 6 is a flowchart showing a communication controlling method according to a second embodiment of the present invention.

### MODE FOR THE INVENTION

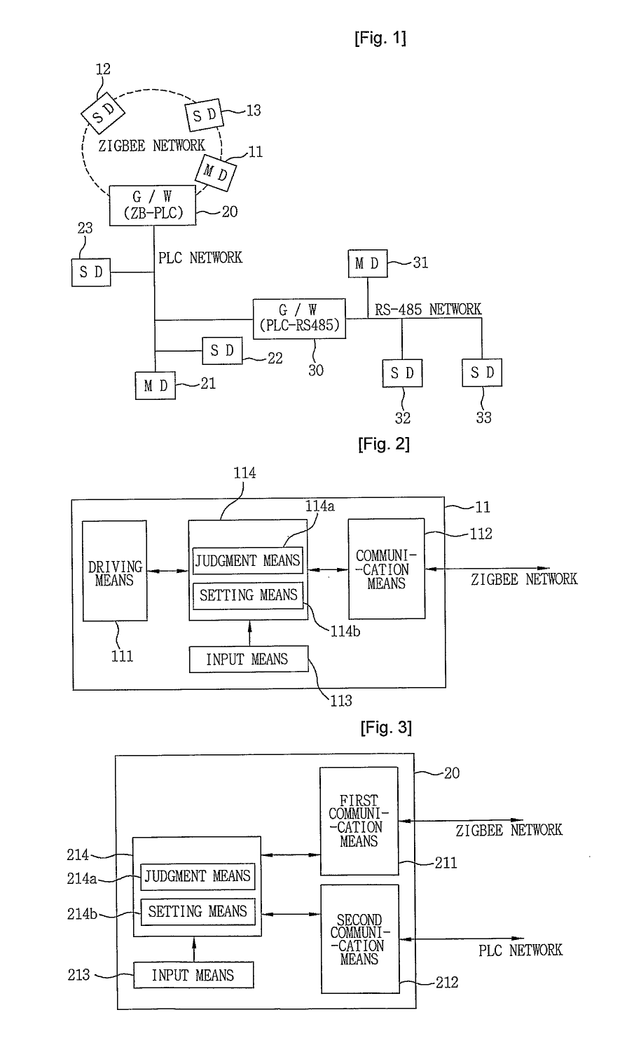

FIG. 1 is a configuration view illustrating a home network system applied with a communication controlling method for a network managing device according to the present invention.

Referring to FIG. 1, the home network system includes networks using three kinds of communication media, i.e., Zigbee network, power line communication (PLC) network and RS-485 network.

First, the Zigbee network includes a master device (MD) 11 that is a network managing device at least controlling and monitoring slave devices (SDs) 12 and 13 that are network devices, and the SDs 12 and 13 performing independent functions (for example, a washing function, refrigerating function, etc.), and at least performing operations under the control of the MD 11.

The PLC network includes an MD 21 that is a network managing device, and SDs 22 and 23 that are network devices, and the RS-485 network includes an MD 31, and SDs 32 and 33. The MDs 11, 21 and 31 may control and monitor all the SDs 12, 13, 22, 23, 32 and 33.

In addition, for the communication between hetero-communication media, the home network system includes a gateway (G/W) 20 for use in communication between the Zigbee network and the PLC network, and a G/W 30 for use in communication between the PLC network and the RS-485 network.

FIG. 2 is a configuration view illustrating the MD that is the network managing device of FIG. 1. As shown in FIG. 2, the MD 11 includes a driving means 111 for performing an independent function (for example, a washing function, refrigerating function, TV function, etc.), a communication means 112 for performing data communication through the Zigbee network, an input means 113 for acquiring a control command or the like from a user, and a microcomputer 114 for controlling the performance of the independent function and the aforementioned components to control and monitor the SDs 12, 13, 22, 23, 32 and 33 in the Zigbee network. Although a power supply unit for supplying power to each component is not illustrated, it is publicly known to those skilled in the art, and thus is not explained.

The driving means 111 is a device for performing the independent function of the MD 11, for example, a freezing cycle, drying cycle, TV receiving and expressing device, etc. The driving means 111 may be provided selectively.

The communication means 112 is an exclusive-use modem or a network adapter for performing the Zigbee network communication. The MD 11 communicates with the SDs 12 and 13 and the G/W 20 through the communication means 112.

The input means 113 acquires a performance command for the independent function or the like from the user. The input means 113 may perform setting or resetting of the communication means 112.

The microcomputer 114 controls the driving means 111 to perform the independent function according to the control command or the like of the user input through the input means 113. In addition, the microcomputer 114 receives various event packets and response packets from the SDs 12 and 13 or the G/W 20 through the communication means 112, and processes the received packets.

In detail, the microcomputer 114 includes a judgment means 114a for judging a speed of the network connected through the communication means 112, or a transmission/reception amount of packets transmitted or received through the communication means 112, and a setting means 114b for setting event transmission intervals of event packets of the SDs 12, 13, 22, 23, 32 and 33 according to the judged speed of the network or the judged transmission/reception amount of the packets.

The microcomputer 114 stores information on a transmission speed that is a characteristic of the network to which the communication means 112 is connected. The transmission speed is associated with a transmission speed of the communication means 112 itself, and also associated with a characteristic of the communication medium that is the network. In addition, in case of the networks applied with various communication media of FIG. 1, one network may receive speed information of the other networks from the G/Ws 20 and 30. Therefore, the microcomputer 114 may judge an increase/decrease amount of an event transmission interval on the basis of the slowest transmission speed or the average transmission speed in the above information. Moreover, the microcomputer 114 stores information on a reference transmission/reception amount of packets to perform optimum data transmission/reception in the corresponding network communication medium.

Accordingly, the judgment means 114a judges the speed of the network or the transmission/reception amount of the packets. First, the judgment means 114a divides the speed of the network into high, middle and low speeds. If the network has a high speed, the judgment means 114a judges that the event transmission interval should be decreased. If the network has a middle speed, the judgment means 114a judges that the preset event transmission interval should be maintained. If the network has a low speed, the judgment means 114a judges that the event transmission interval should be increased. In addition, the judgment means 114a judges a current packet transmission state of the network by comparing the judged transmission/reception amount of the packets with the reference transmission/reception amount of the packets. Here, the reference transmission/reception amount of the packets is given as a predetermined range. If the transmission/reception amount of the packets is over this range, the event transmission interval may be increased. If the transmission/reception amount of the packets belongs to this range, the event transmission interval may be maintained as it is. If the transmission/reception amount of the packets is below this range, the event transmission interval may be decreased.

According to the judgment result, if the judged transmission/reception amount of the packets is over the reference transmission/reception amount, the setting means 114b increases the event transmission interval, thereby decreasing the entire number of the event packets transmitted in the network per hour (second or minute). Therefore, the MD 11 acquires information based on less event packets. Meanwhile, if the judged transmission/reception amount of the packets is below the reference transmission/reception amount, the setting means 114b maintains or decreases the event transmission interval, thereby maintaining or increasing the entire number of the event packets transmitted in the network per hour (second or minute). Accordingly, the MD 11 acquires information based on same or more event packets.

The setting means 114b sets the increase/decrease amount of the event transmission interval according to the judged speed of the network or the judged transmission/reception amount of the packets. The microcomputer 114 transmits the set increase/decrease amount to the SDs 12, 13, 22, 23, 32 and 33 and/or the G/Ws 20 and 30 through the communication means 112.

At this time, a certain value that is the increase/decrease amount may be added or subtracted to/from the event transmission intervals of the entire event packets (hereinafter, referred to as ‘first increase/decrease characteristic). For example, when the events are classified into an event announcing power supply (event transmission interval: 2 min.), an event announcing an operation error (event transmission interval: 1 min.), and an event announcing a performance of an operation (event transmission interval: 5 min.), if a certain value (+3 min.) is added thereto, the above events are reset into an event announcing power supply (event transmission interval: 5 min.), an event announcing an operation error (event transmission interval: 4 min.), and an event announcing a performance of an operation (event transmission interval: 8 min.).

In the meantime, the increase/decrease amounts may be added or subtracted individually to/from the event transmission intervals according to kinds of events (hereinafter, referred to as ‘second increase/decrease characteristic). For example, when the events are classified into urgent events (an event announcing an operation error, an event announcing power off, etc.) and non-urgent events (an event announcing a performance of an operation, etc.), the increase/decrease amounts for the urgent events and the non-urgent events are set respectively. That is, while the event transmission interval of the urgent event is increased by 1 min., the event transmission interval of the non-urgent event is increased by 3 min. Therefore, the event transmission intervals may be increased or decreased according to the kinds of the events. In case of the urgent event, the MD 11 can receive the event packet rapidly, regardless of a traffic situation of the network.

The microcomputer 114 transmits a packet containing the increase/decrease amount through the communication means 112. The increase/decrease amount includes the first and second increase/decrease characteristics described above.

In addition, the MD 11 may further include a display means (not shown) for displaying not only an operation state of the MD 11 but also states of the SDs 12, 13, 22, 23, 32 and 33.

Moreover, when the microcomputer 114 receives an event packet repeatedly during the continuance of an event (for example, a door open event packet, an event packet announcing a performance of an operation, etc.), the microcomputer 114 may store the event packet, and transmit an event response packet to the SD 12, 13, 22, 23, 32 or 33 transmitting the event packet. The event response packet prevents the SD 12, 13, 22, 23, 32 or 33 from transmitting the same event packet repeatedly. Further, the microcomputer 114 may judge the transmission/reception amount of the packets in the network, and transmit the event response packet according to the judgment result.

The other MDs 21 and 31 of FIG. 1 are identical or substantially identical in structure to that of FIG. 2.

FIG. 3 is a configuration view illustrating the G/W that is the network managing device of FIG. 1. Referring to FIG. 3, the G/W 20 includes a first communication means 211 for performing data communication through the Zigbee network, a second communication means 212 for performing data communication through the PLC network, an input means 213 for acquiring an input from the user, and a microcomputer 214 for controlling the aforementioned components to perform communication between hetero-networks. Although a power supply unit for supplying power to each component is not illustrated, it is publicly known to those skilled in the art, and thus is not explained.

The first communication means 211 and the second communication means 212 serve as modems or network adapters corresponding to the connected network communication media, respectively.

The input means 213 may perform setting or resetting of the first and second communication means 211 and 212.

The microcomputer 214 performs an intermediating operation to transmit a packet from the first communication means 211 to the second communication means 212 or from the second communication means 212 to the first communication means 211. If necessary, the microcomputer 214 performs the packet conversion according to protocols of respective network connection media. In addition, the microcomputer 214 includes a judgment means 214a for judging a speed of a network or a transmission/reception amount of packets through the first communication means 211 and the second communication means 212, and a setting means 214b for setting an increase/decrease amount of an event transmission interval of an event packet according to the judgment result. The judgment means 214a and the setting means 214b are identical or substantially identical in function to the judgment means 114a and the setting means 114b of FIG. 2.

Moreover, the microcomputer 214 may generate and transmit an event response packet like the microcomputer 114 of FIG. 2.

The other G/W 30 of FIG. 1 is identical or substantially identical in structure to that of FIG. 3.

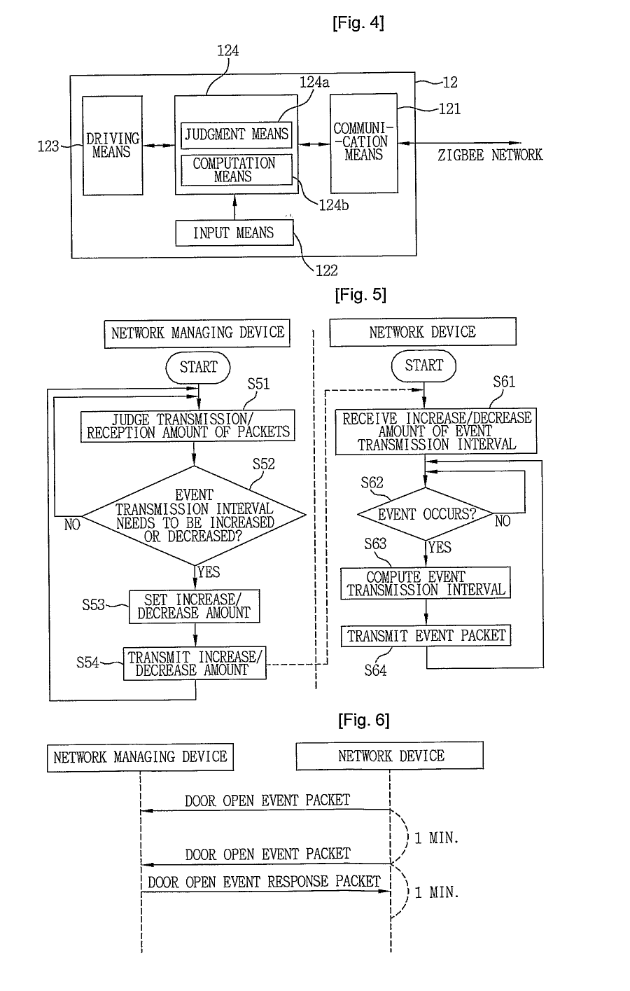

FIG. 4 is a configuration view illustrating the SD that is the network device of FIG. 1.

Referring to FIG. 4, the SD 12 includes a driving means 123 for performing an independent function (for example, a washing function, refrigerating function, TV function, etc.), a communication means 121 for performing data communication through the Zigbee network, an input means 122 for acquiring a control command or the like from the user, and a microcomputer 124 for controlling the performance of the independent function and the aforementioned components to at least perform a control command from the MD 11 in the Zigbee network and transmit an event such as a state. Although a power supply unit for supplying power to each component is not illustrated, it is publicly known to those skilled in the art, and thus is not explained.

The communication means 121 is an exclusive-use modem or a network adapter for performing the Zigbee network communication. The SD 12 communicates with the MD 11 and the G/W 20 through the communication means 121.

The input means 122 acquires a performance command for the independent function or the like from the user. The input means 122 may perform setting or resetting of the communication means 121.

The driving means 123 is a device for performing the independent function, for example, a freezing cycle, drying cycle, TV receiving and expressing device, etc. The driving means 123 may be provided selectively.

The microcomputer 124 controls the driving means 123 to perform the independent function according to the control command or the like of the user input through the input means 122. In addition, the microcomputer 124 receives various control commands and response packets from the MD 11 or the G/W 20 through the communication means 121, and processes the received commands and packets.

Particularly, the microcomputer 124 includes a judgment means 124a for judging whether an event occurs by the input means 122 and the driving means 123, and a computation means 124b for computing an event transmission interval according to an increase/decrease value of the event transmission interval received through the communication means 121. The microcomputer 124 transmits the corresponding event at the event transmission interval applied with the increase/decrease value.

When a characteristic state, operation or error occurs in the SD 12, the judgment means 124a judges whether this event corresponds to a predefined event.

Moreover, when or before such events occur, the computation means 124b computes the event transmission intervals of each or entire events according to the received increase/decrease value. The microcomputer 124 transmits an event packet corresponding to the occurring event through the communication means 121 at the computed event transmission interval.

Further, in a case where the microcomputer 124 receives an event response packet corresponding to the event packet from the MD 11, 21 or 31 or the G/W 20 or 30, even if the event corresponding to the event response packet occurs repeatedly, the microcomputer 124 does not generate and transmit the event packet. Particularly, in this case, the event corresponding to the previously-transmitted event packet continues. For example, a door open state continues.

FIG. 5 is a flowchart showing a communication controlling method according to a first embodiment of the present invention. The flowchart of FIG. 5 shows a method of controlling a traffic of a network by increasing or decreasing an event transmission interval according to a transmission/reception amount of packets of the network. As set forth above, the MDs 11, 21 and 31 and the G/Ws 20 and 30 are network managing devices, and the SDs 12, 13, 22, 23, 32 and 33 are network devices.

At step S51, the network managing device judges a transmission/reception amount of packets of a connected network (for example, Zigbee network, PLC network, RS-485 network, etc.) through the judgment means 114a or 214a.

At step S52, the network managing device confirms whether a current event transmission interval needs to be increased or decreased according to the judged transmission/reception amount of the packets. That is, if the judged transmission/reception amount of the packets is larger than a preset reference transmission/reception amount of the packets, the judgment means 114a or 214a judges that the event transmission interval needs to be increased, and if the judged transmission/reception amount of the packets is smaller than the preset reference transmission/reception amount of the packets, the judgment means 114a or 214a judges that the event transmission interval needs to be decreased. At step S52, if the event transmission interval needs to be increased or decreased, the network managing device goes to step S53, and if not, the network managing device goes to step S51 and judges the transmission/reception amount of the packets continuously.

At step S53, the setting means 114b or 214b of the network managing device sets an increase/decrease amount according to the judged transmission/reception amount of the packets. Here, the setting means 114b or 214b uses the first and second increase/decrease characteristics described above. The microcomputer 114 or 214 of the network managing device stores and manages the set increase/decrease amount.

At step S54, the network managing device transmits the set increase/decrease amount through the network, goes to step S51, and judges the transmission/reception amount of the packets continuously.

The communication controlling method starts in the network device due to the transmission of the increase/decrease amount of step S54.

At step S61, the network device receives the increase/decrease amount of the event transmission interval from the network managing device, and stores it.

At step S62, the judgment means 124a of the network device judges whether a preset event occurs. If the event occurs, the network device goes to step S63, and if not, the network device stands by for the event.

At step S63, the computation means 124b of the network device computes a new event transmission interval according to an increase/decrease value corresponding to the occurring event. Such computation is performed on the basis of the first or second increase/decrease characteristic contained in the increase/decrease value.

At step S64, the network device generates an event packet of the occurring event, and transmits it through the network at the computed event transmission interval. Thereafter, the network device goes to step S62 and judges whether an additional event occurs. At this time, the network device may go to step S61 after step S64, and receive and process an additional increase/decrease amount.

In addition, the step of computing the event transmission interval according to the increase/decrease value in step S63 may be performed after step S61, regardless of step S62.

Moreover, as described above, the network managing device may judge an increase/decrease amount of an event transmission interval according to a speed of a network, and transmit it to the network device.

FIG. 6 is a flowchart showing a communication controlling method according to a second embodiment of the present invention. The flowchart of FIG. 6 shows a communication controlling method using an event response packet.

As a door (not shown) of a network device opens, the network device generates a door open event packet and transmits it to a network managing device through a network. In a case where an event transmission interval of the door open event is, for example, 1 min., if the door open state continues for 1 min., the network device generates the door open event packet again and transmits it to the network managing device.

Therefore, in a state where the network managing device receives the first door event packet and stores a current state of the network device, the network managing device receives the second door open event packet. That is, when the same event continues, the same event packet is transmitted and received repeatedly to thereby cause a traffic problem to the network. In order to avoid this situation, the network managing device generates a door open event response packet and transmits it to the network device, and the network device receives and stores the door open event response packet. The network device does not generate and transmit the door open event packet after 1 min. from the transmission of the second door open event packet (although the door open state continues). Accordingly, the network managing device does not process the same event packet, and the network device does not generate and transmit the same event packet either. Each device does not spend their resources to transmit, receive and process the same packet.

According to the response packet, the network device does not generate and transmit an additional event packet. If the door closes and reopens, the network device transmits a door close event packet, and then generates and transmits a door open event packet.

The present invention has been described in detail with reference to the embodiments and the attached drawings. However, the scope of the present invention is not limited to the embodiments and the drawings, but defined by the appended claims.

1. A communication controlling method for a network managing device, comprising the steps of:
judging a speed of a network connected with the network managing device or a transmission/reception amount of packets;
setting an increase/decrease amount of an event transmission interval of a network device according to the judgment result; and
transmitting the set increase/decrease amount of the event transmission interval to the network device through the network.

2. The communication controlling method of claim 1, wherein the setting step sets the increase/decrease amount as a constant value for all events.

3. The communication controlling method of claim 1, wherein the setting step sets the increase/decrease amounts individually according to kinds of events.

4. The communication controlling method of claim 1, wherein the setting step sets the increase/decrease amount to be proportional to the transmission/reception amount of the packets.

5. The communication controlling method of claim 1, wherein the setting step decreases the event transmission interval when the network has a high speed, and increases the event transmission interval when the network has a low speed.

6. The communication controlling method of claim 1, wherein the network managing device is a master device or a gateway.

7. A communication controlling method for a network device, comprising the steps of:
receiving an increase/decrease amount of an event transmission interval from a network managing device; and
when an event occurs, transmitting a packet corresponding to the event to the network managing device at the event transmission interval reflected with the increase/decrease amount.

8. The communication controlling method of claim 7, wherein the transmitting step comprises a step of computing the event transmission interval according to the increase/decrease amount.

9. The communication controlling method of claim 7, wherein the computing step adds or subtracts the increase/decrease amount to/from the event transmission interval according to kinds of events.

10. A communication controlling method for a network managing device, comprising the steps of:
receiving an event packet from a network device; and
transmitting an event response packet to the network device with respect to the event packet.

11. A communication controlling method for a network device, comprising the steps of:
when an event occurs, transmitting an event packet corresponding to the event to a network managing device;
receiving an event response packet corresponding to the event packet from the network managing device; and
stopping the transmission of the event packet corresponding to the event according to the event response packet.
